(19) United States
(12) Patent Application Publication
(10) Pub. No.: US 2004/0243486 A1
(43) Pub. Date: Dec. 2, 2004

(54) Web server

(76) Inventors: Andrew Butler, Letchworth Hertfordshire (GB); Neil Poole, Letchworth Hertfordshire (GB)

Correspondence Address: FISH & RICHARDSON, PC, 12390 EL CAMINO REAL, SAN DIEGO, CA, 92130-2081, US

(21) Appl. No.: 10/479,005

(22) PCT Filed: May 17, 2002
(86) PCT No.: PCT/GB02/02329

(30) Foreign Application Priority Data
May 25, 2001 (GB) 0112839.6

(51) Int. Cl. G06F 17/60; G01D 1/00; G06M 11/04; G06F 15/16; G06F 15/00

(52) U.S. Cl. 705/28; 709/203; 702/128

(57) ABSTRACT

A web server and data warehouse (1) is provided to enable one or more suppliers of goods or services (4) to service one or more customers (10). Communication between the suppliers, customers and web server uses the internet (3) which is accessed using local internet service providers (2, 5, 9, 11) to minimise telephone call costs. The web server (1) provides automated websites by means of which suppliers can set parameters for goods or equipment at the customer sits. The customer sites transmit measured parameters to the website.

The invention relates to the provision of a web server and data warehouse to which a plurality of suppliers of goods or services have access using individual websites.

There are a variety of circumstances in which a supplier of goods or services may wish or need to have access to data which is held by customers of the supplier. This may arise when the customer has plant or machinery on remote sites which is leased from the supplier and responsibility for the continuing serviceability of the plant or equipment remains with the supplier. Another situation in which the supplier may need to have access to information from customer sites is where the customer wishes to arrange for automatic re-ordering of goods as they are consumed. For example, a process operated by a manufacturer may depend on the continuous supply of raw materials and the customer may wish to arrange for the supplier to replenish the stocks of materials when stocks fall to a given level in order to ensure the continuous operation of the manufacturing plant. This has previously required the customer to monitor the quantity of raw materials remaining in stock and their usage rate and when they fall to a given level to raise an order on the supplier. If the customer fails to do this in time then the plant or machinery may have to be halted while supplies of raw material are obtained. The customer needs to keep up to date records of the lead times of the supplier for supplying the goods or materials.

When a supplier leases plant or equipment to a customer and is responsible for maintaining that plant or equipment in good working order, the supplier has to monitor continuously the performance of the plant or equipment. Various telemetry schemes have been used in order to perform this remote monitoring and when faults are detected the supplier has to contact a service organisation, either internal or external, to attend the site and repair the plant or machinery. All these situations require the intervention by humans in the process and require the human interveners to monitor the state of the remote sites.

The invention comprises the provision of a web server and data warehouse to which a plurality of suppliers of goods or services have access using individual websites hosted by the server, each website having associated therewith data memory which is arranged to store data received at the suppliers website over the internet from a plurality of remote terminals arranged at sites owned or operated by a customer of the supplier, access to each website being restricted to the supplier, to customers of the supplier, or to service or delivery organisations contracted by or belonging to the supplier, wherein the server is arranged to enter the data received by the website into the associated memory to monitor and/or process the stored data to detect a critical state at a remote terminal, and on detection of a critical state to notify a person responsible for restoring the site to a non-critical condition of the critical state.

The server may be arranged to notify the person responsible by generating and transmitting an e-mail message. Alternatively the server may be arranged to generate and transmit a call to a pager or to a mobile telephone.

By using the invention a supplier may automatically alert a maintenance and repair or haulage business whenever attention is needed at the site. In the case of plant and machinery a maintenance organisation may be directly notified by the server of a fault condition and may be given access to the website to determine the fault that has caused the call-out, thus enabling the service organisation to ensure that the relevant equipment is taken by the service personnel to the site in order to rectify the fault.

In an alternative situation where the supplier is supplying raw materials which are consumed at the site the server is arranged to notify a delivery organisation that a delivery is required to that particular site. The delivery organisation is then enabled to schedule a visit to the supplier to collect the goods and to the site to deliver them. Again the delivery organisation is given access to the website to enable it to determine the particular raw materials' which have to be collected and delivered and the particular sites where delivery is required. The supplier may have control over the website in order to indicate to a service organisation or delivery organisation whether or not it is prepared to supply further materials or services to that site in the light of the current state of the customer's account with the supplier.

The owner or operator of the web server and data warehouse may lease websites and memory to a plurality of suppliers to enable the monitoring of the remote site to take place. The owner of the web server and data warehouse may also provide the monitoring equipment at the remote terminals to enable the state of the remote sites to be determined.

The invention enables the owner and operator of a web server and data warehouse to provide a service in which a plurality of suppliers of goods or services have individual websites hosted by the server, each website having a data memory associated with the website and processing power which is capable of manipulating data stored in the data memory. The website enables each supplier to gather information from its own customers, to have that information processed and to take appropriate action. The owner and/or operator of the web server may provide the suppliers with a service which enables them to monitor and control remote sites without needing to have an intimate knowledge of the data manipulation taking place in the server. Thus the owner and/or operator of the server will provide a website which enables both suppliers and customers of the supplier to enter appropriate parameters using the website and the web server will provide the manipulation on the data which enables the supplier and/or customer to take appropriate action. The owner and/or operator of the web server may also provide the monitoring equipment at remote sites but this is not an essential feature as the web server can be arranged to accept data from any monitoring equipment.

The invention further provides a method of restoring any of a plurality of remote customer sites to a given condition comprising the steps of:

providing a web server hosting one or more web sites, each web site being controlled by a supplier of goods or services to a plurality of customers;

providing respective data store(s) associated with the web site(s)

receiving at a web site data from each of a group of remote customer sites, the data representing the current or recent state of the remote site,

storing the received data in the associated data store;

processing the stored data to determine whether a critical condition exists at any of the remote customer sites; and,

if such a critical state is determined notifying a person or organization responsible for restoring the remote site to a given state of the existence of the critical state.

The above and other features and advantages of the invention will be apparent from the following description, by way of example, of embodiments of the present invention with reference to the accompanying drawings in which;

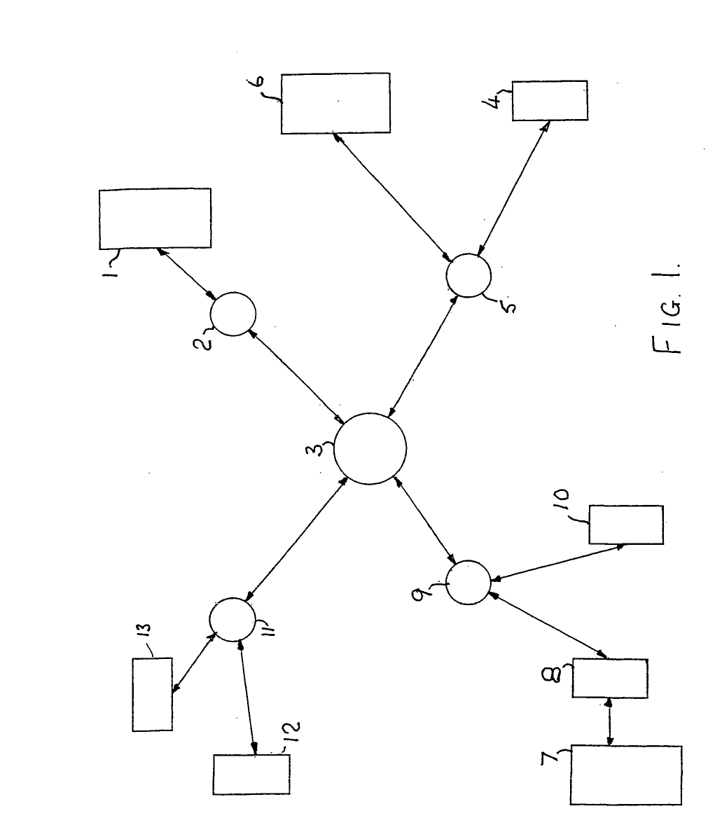

FIG. 1 shows in block schematic form a first embodiment of a system according to the invention that is arranged to monitor the state of goods at a remote site;

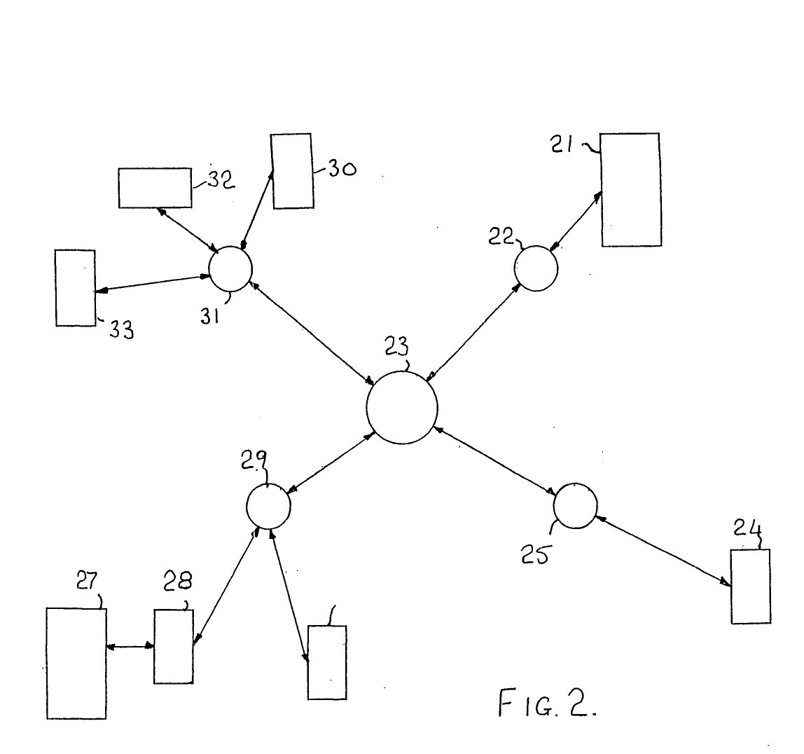

FIG. 2 shows in block schematic form a second embodiment of a system according to the invention that is arranged to monitor the state of plant or machinery at a remote site;

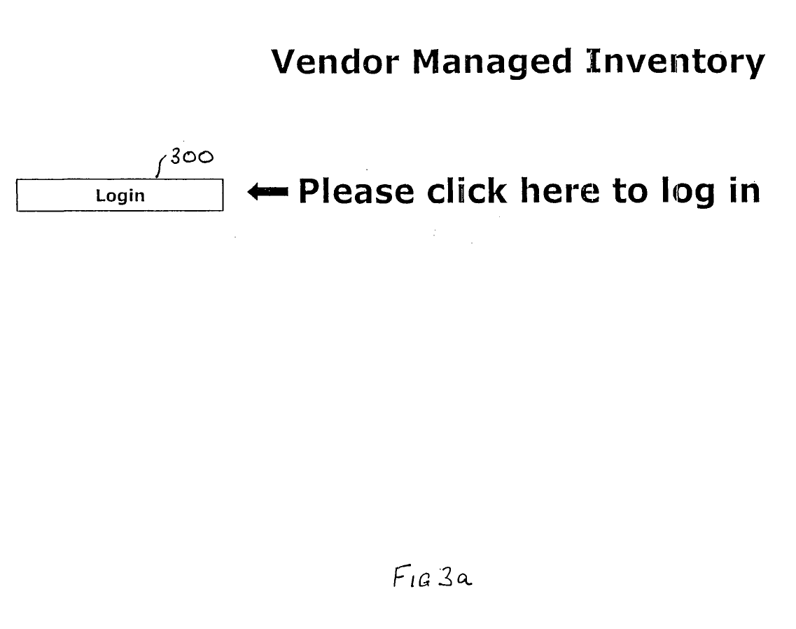

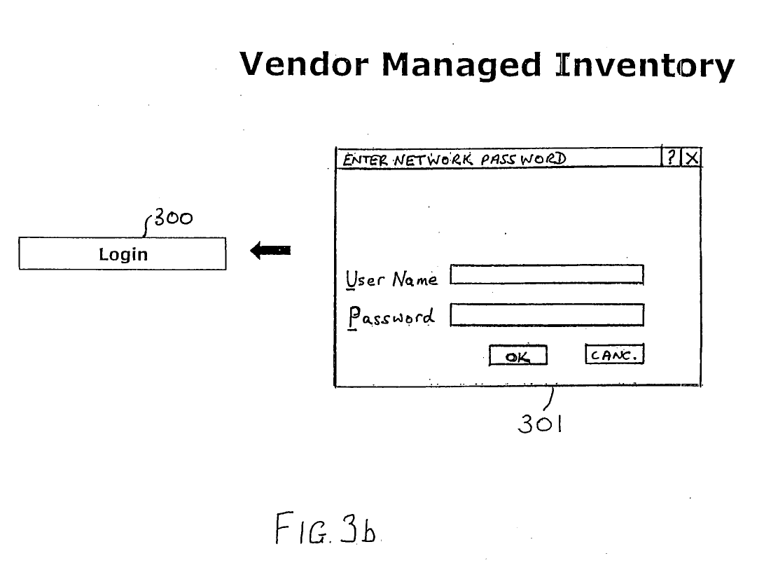

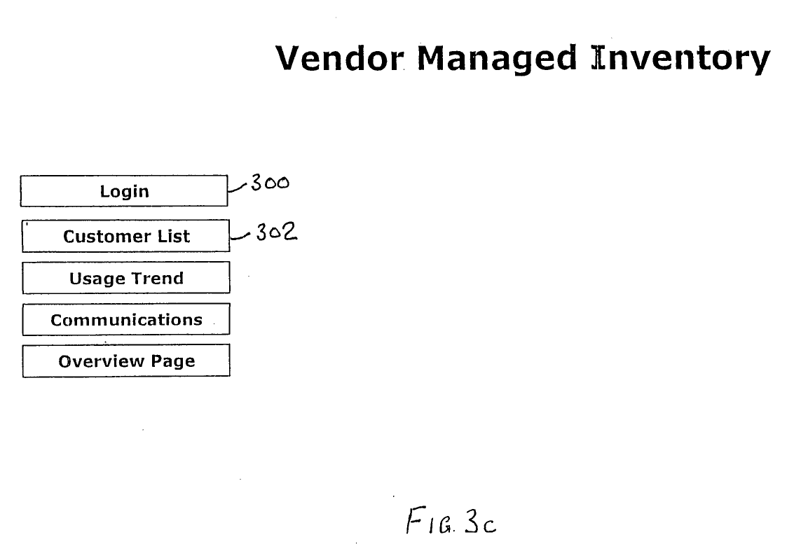

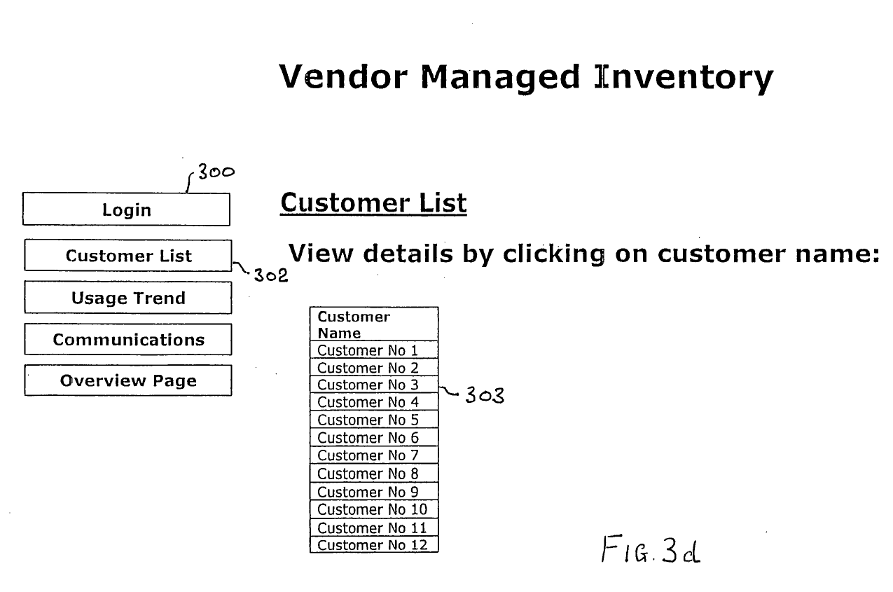

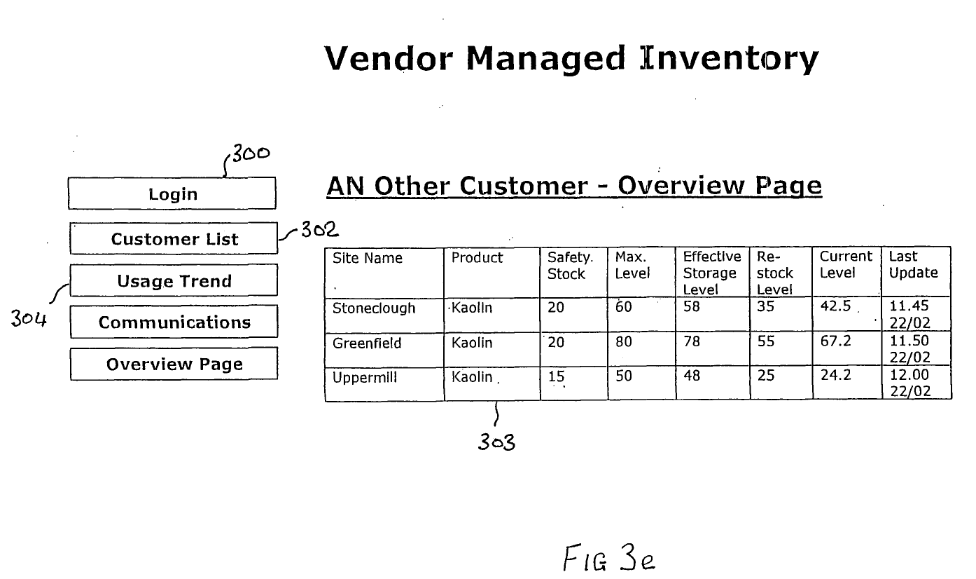

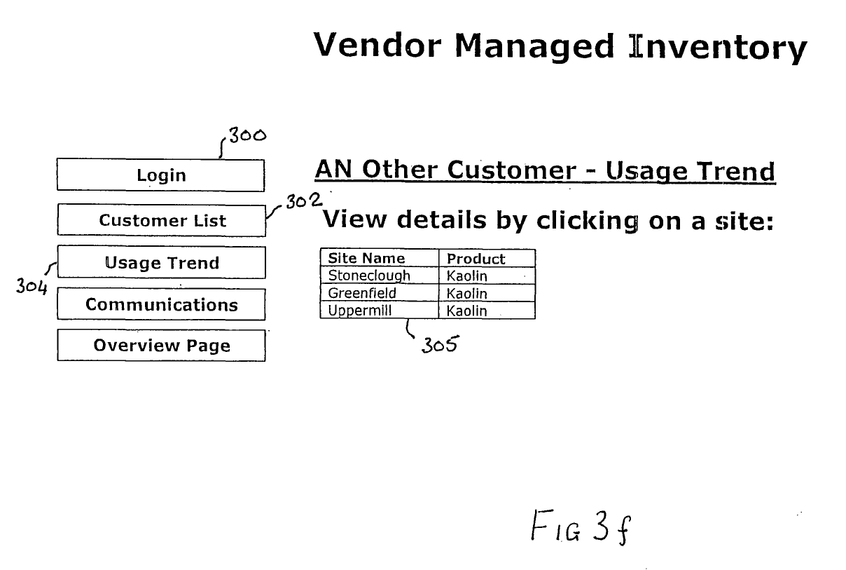

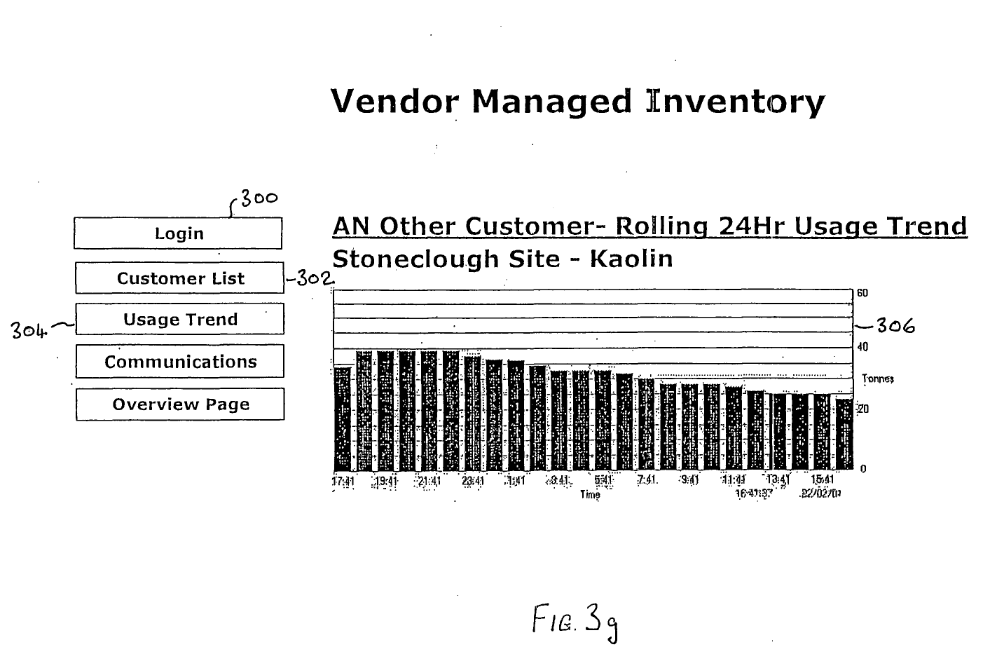

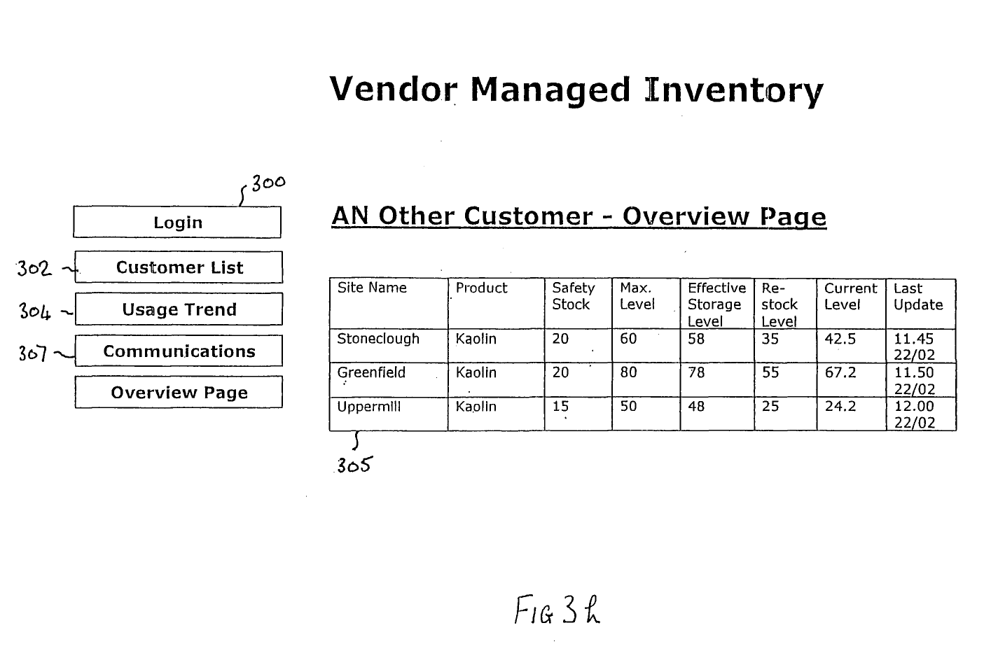

FIG. 3 a-j illustrates web pages which are presented to a user of the system shown in FIG. 1;

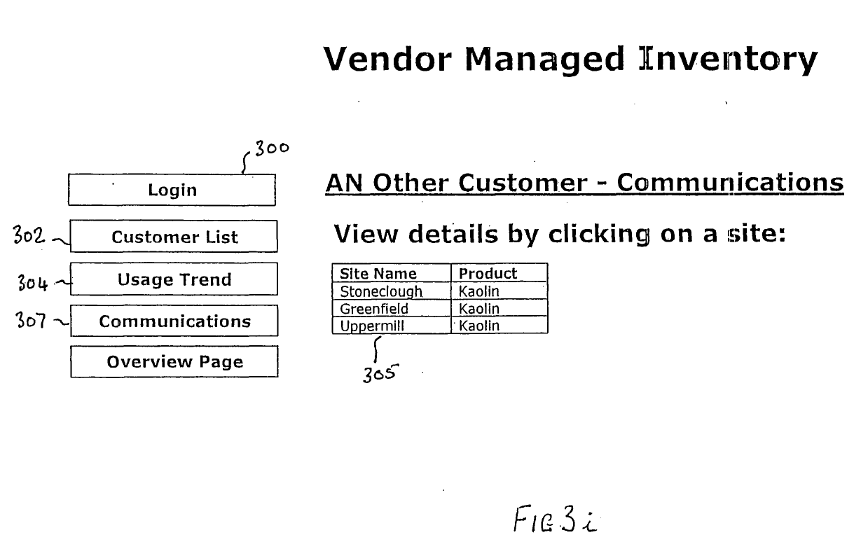

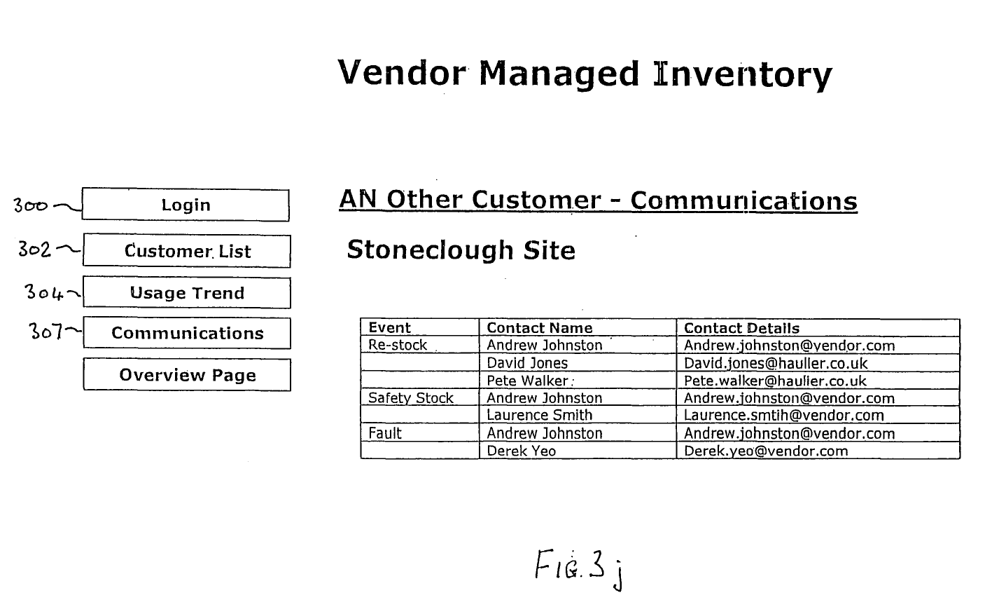

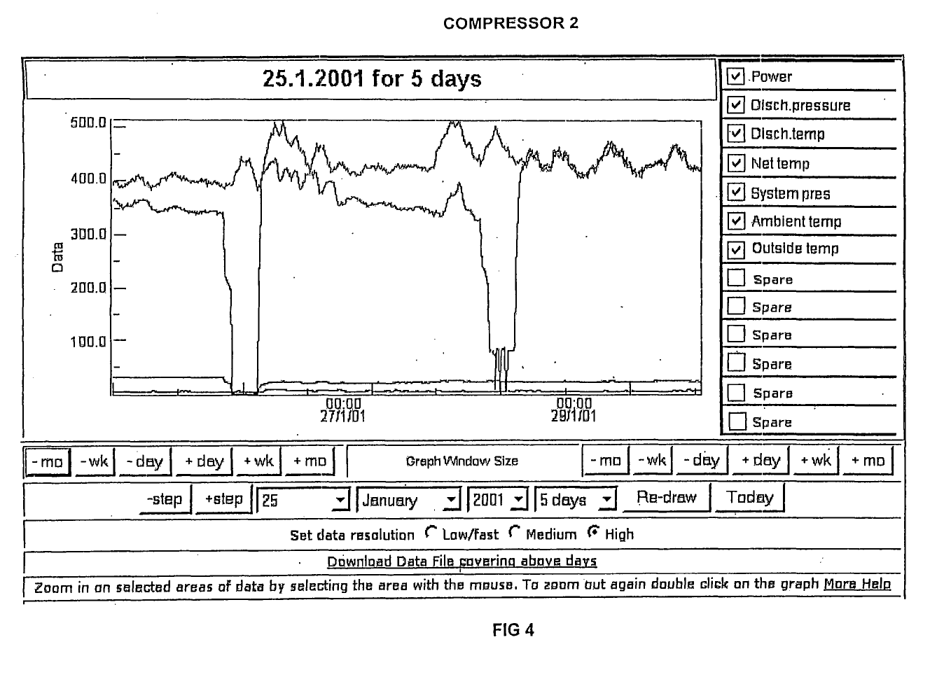

FIG. 4 is a web page showing in graphical form historical measured parameters for a compressor at the customer site;

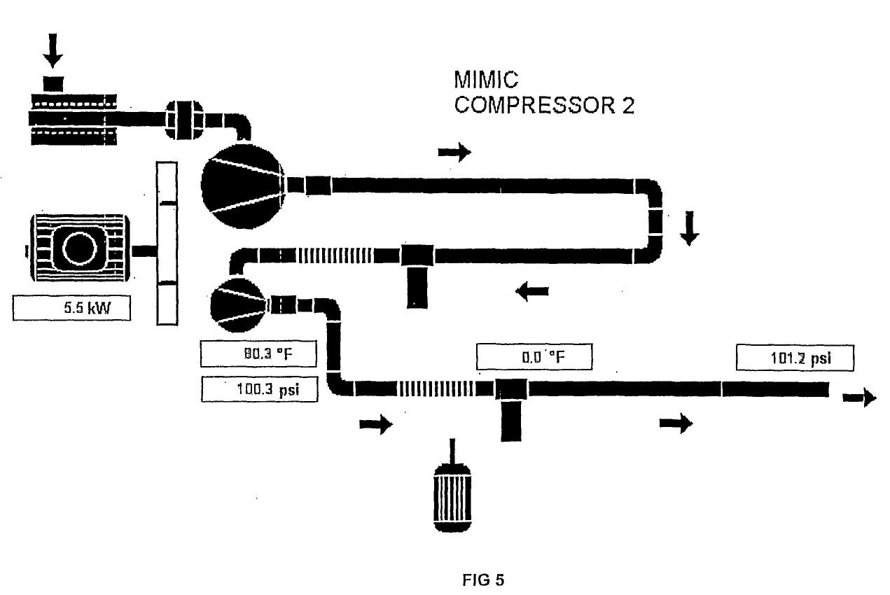

FIG. 5 is a schematic diagram as shown on the website of a compressor having superimposed thereon measured parameters; and

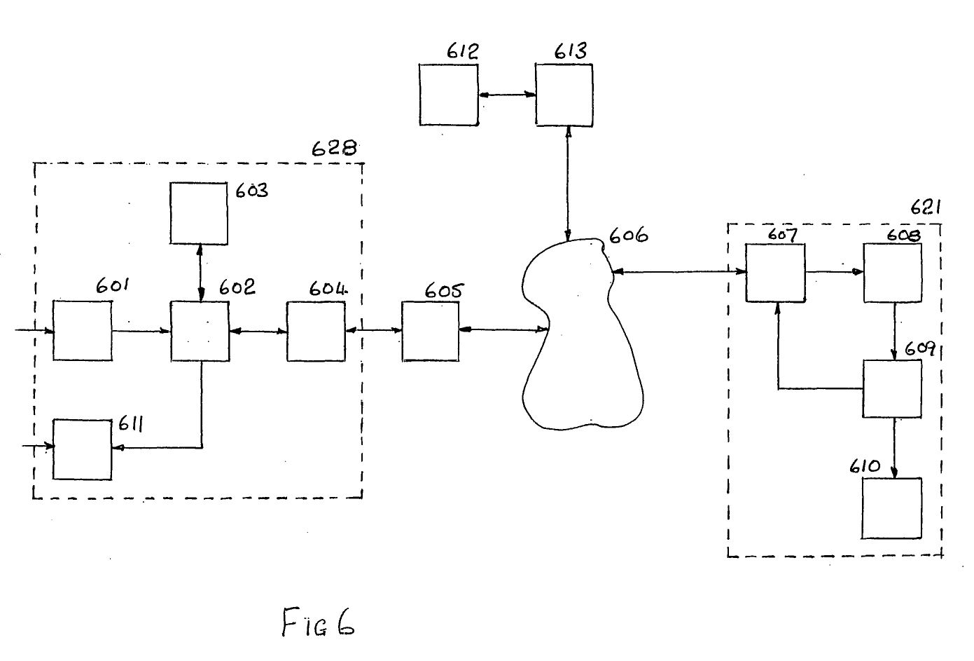

FIG. 6 shows in block schematic form further details of the monitoring unit 8 and 28 at the remote sites 7 and 27 and of the-central server 1.

The system shown in FIG. 1 comprises a server 1 which provides a dedicated website and data warehouse. It includes memory and a processor that enables data which is received via the website to be stored and manipulated. The server 1 comprises a secure web server and data warehouse and provides one or more automated websites and a data processing capability enabling the generation and display of graphics showing trends in data received from the remote terminals and supervising control and data acquisition (SCADA) graphics. The server 1 also allows the supplier and/or customer to enter re-stock set points and alarm set points. The server 1 is connected via a local internet service provider 2 to the internet 3. A supplier of goods or materials is provided with a terminal 4, which may be a personal computer. The terminal 4 is connected via a local internet service provider 5 to the internet 3. The terminal 4 may be further connected via the local internet service provider 5 to a central computer system 6 run by the company supplying the goods or materials. Alternatively the terminal 4 may be connected to the computer system 6 by a local area network if it is on the same site as the computer system 6 or by private network internal to the supplier.

The supplier, using the terminal 4, manages the system via interactive web pages on the website hosted by the server 1 using a web browser and may set re-stock levels, alarm set points, and communication links to selected persons or organisations.

A monitoring unit 8 is provided at a remote site 7 which monitors the state of the inventory at the remote site 7. The monitoring unit 8 is connected via a local internet service provider 9 to the internet 3. In this way calls from the monitoring unit 8 are charged at the local rate minimising charges. The monitoring unit 8 may take many forms but usually will include automatic sensors which enable the quantity of goods or materials remaining at the remote site to be determined. Possible forms for the monitoring unit 8 include detection circuits for sensors that are able to monitor selected parameters of the goods or materials stored at the remote site. These parameters may include quantity, temperature, expiry date and other properties of the goods. The sensors could include limit switches, temperature sensors, usage rate detectors, etc. Alternatively the sensors could be point of sale terminals which monitor the goods as they are sold. In the latter case, the monitoring unit 8 has the quantity of goods delivered stored in memory and subtracts those sold from the quantity stored in memory using information received from the point of sales terminals. A further terminal 10 may be provided at the remote site to enable a customer to monitor the output of the monitoring unit 8 and also to connect via the internet to the server 1 or to the central data processing unit 6 of the supplier.

The supplier is also able to communicate with a haulier to enable delivery of goods from the supplier to the customer site 7. The haulier has a terminal 13 which is connected to the internet 3 via a local internet service provider 11. The haulier may also have a WAP enabled cellular phone 12 which enables data to be received via the internet 3. In this way the haulier can acknowledge a delivery request and enter a predicted date/time for pick up and delivery.

The supplier using the system illustrated in FIG. 1 is enabled to monitor the state of the supplies at sites of one or more customers and may thus organise the replenishing of stocks as they are used. At the remote site the monitoring unit 8 is able to monitor the state of the stocks of goods or materials at the site 7 and, optionally, their rate of usage and to communicate with the server 1 via the internet 3 using the local internet service provides 9. Calls from the monitoring unit 8 to the local internet service provider are charged at local telephone call rates minimising the call charges, particularly when the remote site is outside the local tariff area of the server. The monitoring unit 8 is capable of interacting with the website on server 1 and may initiate calls to the server 1. Since the server 1 is able to handle simultaneous calls to the website, it is not necessary for it to poll all the remote sites and data may be transferred from the remote site at a time controlled by the remote site. As a result it is not necessary to limit transmission from the remote site to the server to fixed intervals between data transfers and the data transfer can happen immediately if the conditions are such that this is required. Alternatively, of course, it is possible for data to be sent at regular intervals where the possible delay introduced is not critical or to use a combination of regular and immediate transmission depending on the urgency of the information to be transmitted.

The server 1 provides a website and data warehouse which is able to receive and store the data from remote sites and to calculate re-stock set points, alarm set points, usage rates, etc. These stored and calculated values are then made available on the website and may be then accessed by the supplier using the data terminal 4. The supplier may also interact with the web site to define is alarm set points, re-stock set points and any other parameters which may be relevant. The supplier terminal 4 may interact with the computer system 6 either via the internet service provider 5 or directly using a local area network if the terminal 4 is on the same site as the computer system 6. The computer system 6 will contain data as to billing of the customer, the authorisation for the haulage company to deliver goods, records of the haulier collecting the goods from the supplier and also control the connection to an extranet for customers of the supplier who may access selected portions of the data in the computer system 6 using the extranet via the terminal 10 and local internet service provider 9.

FIG. 3 a-j shows how the supplier may interface with the website on the server 1 using the terminal 4. FIG. 3a shows the first page which is presented when the supplier logs on to the website on the server 1 using the terminal 4. It will be seen a soft button 300 is provided onto which the supplier clicks in order to start the login process. In response to a click on the login button 300 a dialogue box 301 is provided as shown in FIG. 3b, which invites the user to enter a user name and password. Assuming that the user name and password is authorised, this will allow the user to access those web pages where they are listed in the user group. Having entered the correct user name and password, the user will then have access to those web pages for which they are authorised and will not need to authorise their user name or password again during that browsing session. The user will, of course, have to enter their user name and password again when attempting to browse the web pages on another occasion. Once the user has passed through the security steps, the user will then be presented with an option to view a customer listing showing all the customers using the vendor managed inventory system. FIG. 3c shows the is next page that is presented. This page has two soft buttons, the login button 300 and the customer list button 302. Once the user clicks onto the customer list button, a further page is presented which contains a customer list 303 as shown in FIG. 3d. The supplier can then select a particular customer from the customer list by clicking onto that customer name on the list and once the supplier selects a customer, the page shown in FIG. 3e which comprises a customer overview window is presented. In this particular example the selected customer has silos at various sites which store kaolin. Clearly the customer may have any number of sites and store any material or article. The particular monitoring means for quantities remaining will be chosen according to the nature of the materials or articles. As shown in FIG. 3e, the customer overview window shows the sites and silos that the customer has connected to the vendor managed inventory service. This is a key page for each customer presenting all the details on the silo, its content, restocking levels, current stock levels and time/date when data was last updated from the site. It will be seen that in addition to the details displayed as listed above the page shown in FIG. 3e also contains a soft button 304 labelled usage trend. Clicking on the usage trend button 304 will present the user with a list of sites from which they can select yet further to see a graph of the last 24 hours usage of material in a particular silo. FIG. 3f shows the list of silos 305 for a particular customer and the user can select a particular site/silo by clicking on the site/silo name. The page shown in FIG. 3g will then be presented which contains graphics 306 showing the level in the chosen silo on a rolling 24 hour basis. By returning to the overview page, FIG. 3h, the user may now view the communications that have been set up for each site by clicking the communications button 307. The page shown in FIG. 3i is then displayed and the user can then select the site from a list by clicking directly on the site name 305. This causes the communications setup for that site to be displayed, as shown in FIG. 3j. The table shows the events, contact names, and contact details. Events will trigger emails to those listed in the table. Should the silo level fall below the desired restock level, then an email will be sent. Similarly, a safety stock level can be set. Under normal conditions the silo level should never drop this low. If the silo falls below the safety stock level, then a warning email is sent to alert the supplier's vendor managed inventory systems manager that he may need to intervene to ensure that a delivery is organised in time to prevent the customer running out of stocks.

Should a fault occur at a particular site logged by the website, then a third level of email may be sent to the systems manager and a course of action to clear the fault may commence. The systems manager will communicate the actions and time scales to clear the fault to the supplier so that the supplier can take action to ensure that stocks at that site are maintained even when the supplier is not automatically receiving information as to the stock level.

Once the fault is clear the systems manager will notify the supplier.

The system described with reference to FIGS. 1 and 3 shows how a supplier can use a vendor managed inventory system to ensure that customers have sufficient stocks at their sites. This is achieved through using a website on a central server and communicating with the website by means of the internet. This enables communication from the supplier, the customer and delivery companies using local internet service providers and the internet in order to communicate with the website. By this means an inexpensive method of communication can be implemented in that each of the supplier, the customer sites, and the haulier can use a local internet service provider so that the communication is at local call rates. This is particularly important when the supplier and the customer are in different countries where normal telecommunications costs for communication between the two parties tends to be expensive. Thus, by using the internet to couple all these terminals to the website the costs of communications can be reduced. In addition, because of the concept of providing a website at the central server, each of the sites can communicate with the website by initiating the communication themselves. This is different from the conventional monitoring systems where a central computer polls a number of outstations or remote sites at regular intervals. In these systems it is not possible for the outstation to initiate the communication as the central computer is normally only able to receive one call at a time and the outstation will not know whether the central computer can service the call. By using a website it is possible to allow multiple outstations to communicate with the server simultaneously.

FIG. 2 shows a system in which an equipment supplier can manage the maintenance of equipment at a number of customers' sites. For example, the manufacturer of a compressor may wish to monitor the performance of compressors at different customer sites and arrange for appropriate maintenance and/or repair based on the parameters of the compressor which are measured on site and transmitted back to a website provided on a central server. Thus, as shown in FIG. 2, a central server 21 hosting an automated website is connected to the internet 23 via a local internet service provider 22. The server comprises a secure web server and data warehouse and provides one or more automated websites and a data processing capability enabling the generation and display of graphics showing trends in data received from the remote terminals and supervisory control and data acquisition (SCADA) graphics. The server 1 also allows the supplier and/or customer to enter re-stock set points and alarm set points. The compressor manufacturer is provided with a terminal 24 which can access the website via the internet using an internet service provider 25. The compressor manufacturer, using the terminal 24, can access the website on the server 21 to set up the format of management reports generated from data received at the server 21 from the remote sites and set up alarm set points and other critical data via the website using a web browser. At remote customer sites equipment or plant such as a compressor 27 is connected to a monitoring unit 28 which contains sensors and communications equipment enabling parameters of the compressor 27 to be transmitted via a local internet service provider 29 and the internet 23 to the website on the central server 21. A maintenance and service organisation is provided with a terminal 30 which is connected via a local internet service provider 31 to the internet 23 and thence to the central server 21. The terminal 30 may take any convenient form, for example, a personal computer or a laptop computer. In addition to or instead of the terminal 30 an individual maintenance worker may be provided with a mobile communications device 32 providing a text messaging service or a WAP enabled cellular telephone 33 to enable access to the website on the server 21.

The central server 21 hosts web pages which display service reports, supervisory control and data acquisition (SCADA) graphics and graphical histories providing an illustration of the performance of the equipment at the various sites. The terminal 24 allows the manufacturer to provide site customisation and event configuration at each site. The compressor manufacturer is also able to set the input/output configuration and communications information at the sites 27 using the central server 21. The central server 21 receives and stores service reports generated by the service organisation and entered through the terminal 30. The compressor manufacturer accessed these service reports in order to monitor that the service and maintenance schedule has been followed and that tasks which have been specifically required of the service and maintenance organisation have been carried out. This record may also be used for checking against invoices received from the service and maintenance organisation.

In order to set up the system at each individual remote site, the installation process uses a portable computer (not shown). The initial procedure is to connect sensors which are mounted on the compressor 27 to the monitoring unit 28. The installer uses the portable computer to connect to the monitoring unit 28 so that it can monitor the processes within the monitoring unit 28. The monitoring unit 28 is connected to a telephone line so that it can telephone the local internet service provider and log on to the website in the central server 21 submitting its own unique identification number. The monitoring unit 28 now provides a setup page which can be viewed via the portable computer prompting for a log in name and password. The installer inserts the details using the portable computer and clicks on submit. The installer proceeds as if he had the correct security access. The monitoring unit 28 now serves initial setup screen. The installer enters the site physical location and customer name. Input/output allocation is fixed, that is, for example input one always indicates the output temperature using a sensor producing 4 to 20 milliamp signals representing a sensed temperature of 0-100° C. The installer then clicks submit and sends the details of the input/output allocation to the website. The website downloads a configuration file to the monitoring unit 28 giving, for example, alarm conditions and the times at which the monitoring unit 28 should connect to the central server. It will also give those exception conditions that should generate an immediate transmission to the website. Once the installation procedure is complete, the installer logs off the website and secures the monitoring unit 28 in its enclosure.

Table 1 gives an example of an event configuration page with the sensor inputs and normal operating boundaries which may be set by the manufacturer using the terminal 24 and the website on the server 21. Table 2 shows details of how site selection may be configured and Table 3 shows examples of contact details and the way in which they may be set out.

TABLE 1

| | |
|---|---|
| Compressor | ‘Normal Operating Boundaries’ |

| Sensor Input | Min | | Max | |
|---|---|---|---|---|
| 1 | +25° | C. | +45° | C. |
| 2 | 75 | psi | 110 | psi |
| 3 | +25° | C. | +85° | C. |
| 4 | 10 | kw | 12 | kw |
| 5 | +25° | C. | +45° | C. |
| 6 | 75 | psi | 110 | psi |
| 7 | +25° | C. | +85° | C. |
| 8 | 10 | kw | 12 | kw |
| 9 | +25° | C. | +45° | C. |
| 10 | 75 | psi | 110 | psi |
| 11 | +25° | C. | +85° | C. |
| 12 | 10 | kw | 12 | kw |
| 13 | +25° | C. | +45° | C. |
| 14 | 75 | psi | 110 | psi |
| 15 | +25° | C. | +85° | C. |
| 16 | 10 | kw | 12 | kw |

TABLE 2

| Customer Name | Joes Ltd |
|---|---|
| Site Location | Avon |
| Site Identity | 01234568 |

TABLE 3

| Contact Name | e-mail Address |
|---|---|
| John Smith | John.smith@joes.com |
| Pete Smith | Pete.smith@joes.com |
| Paul Smith | Paul.smith@joes.com |
| Contact Name | SMS Address |
| John Smith | 0775 456 894 |
| Pete Smith | 0778 433 678 |
| Paul Smith | 0778 433 679 |

At the central server 21 data from all the sites is collected by the website and may be manipulated in known ways in order to present performance data of the various compressors on the different sites in graphical form for the compressor manufacturer to monitor. FIG. 4 shows a graphical representation of various conditions in a compressor over a period of five days. Such graphical histories may be produced in known manner once the data is regularly received from each of the sites. Various other graphics may be provided. The compressor manufacturer may provide schematics of the compressor assemblies on which the conditions at various points as detected by the sensors and transmitted by the monitoring unit 28 to the central server 21 are displayed. These conditions may be updated at any given instant by the central server requesting an update from the monitoring unit 28 or may display the conditions measured at the compressor the last time the monitoring unit 28 transmitted them to the central server. When a fault condition has been detected it is normal for the control and monitoring unit to make a special transmission to the central server 21. The graphic as shown in FIG. 5 will then be updated and will become available to the service and maintenance organisation through the terminal 30. This will enable the service and maintenance organisation to make some initial diagnosis of the fault and be prepared with the appropriate equipment when travelling to site to rectify the fault.

The monitoring unit 8 at each site consists of a computer and interfacing circuitry to collect measurements from plant and equipment and/or commodities. The monitoring unit 8 connects with a global network such as the internet using radio or telephone systems, thus a permanent connection is not required. The monitoring unit is configured to check its own measurements and to transfer significant changes to the website on the central server 1 or 21. In this way the information on the server is kept up to date with changes without a permanent network connection, thus allowing the use of temporary network connections such as the public switched telephone network. The information to be transmitted from the monitoring unit 8, 28 could be a significant change in the level of a storage facility or a significant change in the output of a particular piece of machinery. In addition, the monitoring unit 8, 28 may be set to remember minor changes in measured parameters and to upload these as a block at fixed time intervals so as to provide fine detail on these changes for later analysis. The uploaded data may be identified with time and/or data information and may contain a unique identifier to identify the site to the central server 1, 21. The data received at the website on the central server 1, 21 could be used to alert an operator that a connection with a particular outstation has been established. The downloaded control information may contain a command code to ensure that the monitoring unit 8, 28 remains connected to the central server 1, 21 for an extended time set by the command code so that a human operator utilising the website on the central server 1, 21 can manually cause dataflow from or to the monitoring unit 8, 28 in an interactive way. The extended time set by the command could be indefinite and the user would then include a command to manually disconnect from the central server 1, 21 once the interactive control operation has taken place.

It will be apparent that, because the monitoring units 8 and 28 include means for accessing a global network such as the internet using the public switched telephone network, an intermittent connection may be achieved so that call charges are only incurred when a communication has to take place. In this way the public network can be used and the provision of expensive private networks is not required.

In addition, the alternative of using the central server to poll all the different sites is avoided. This enables the various sites to immediately communicate with the central server should an alarm condition take place. If the central server is required to poll the monitoring units it may be some considerable time after the occurrence of an alarm event before the central server polls that particular site. Thus, a fast reaction to the alarm condition may not be possible under these circumstances.

FIG. 6 shows a system which is similar to those shown in FIGS. 1 and 2 but shows the monitoring unit 8 or 28 and the central server 1 or 21 in greater detail. As shown in FIG. 6 the monitoring unit 628 comprises an input interface 601 which accepts electrical signals from the plant or machinery or from sensors detecting the quantity or use of goods or materials and converts it into a form which is suitable for application to a microprocessor 602. The microprocessor 602 has associated with it a read write memory 603 in which tables of parameters may be stored. These parameters may represent set points which indicate, for example, maximum and minimum temperatures, pressures or other quantities or maximum and minimum rates of change of these properties. The memory 603 may include further values which determine the change of any input signal that should be considered to be significant and which requires that the monitoring unit 628 notifies the rest of the system of this change without delay.

The monitoring unit 628 includes a modem 604 which enables information to be transmitted to the central server 621 using a local internet service provider 605 and the internet 606. The monitoring unit 628 is arranged to cause the modem device to connect to a local internet service provider over existing public switched telephone network. It will be apparent that this connection may be temporary and only made when one of the preset limits is exceeded or at preset time intervals. An existing global network data connection 606, which may be the internet, provides a two way data path between the central server 621 and the monitoring unit 628.

Data sent by the monitoring unit 628 via the modem 604 is received by a website 607 hosted by the central server 621 and fed to a database 608. This data is registered as new data values and in this way the database 608 maintains a copy of all the latest significant changes which have occurred in the monitoring unit 628. There may be many monitoring units all communicating with the central server 621.

A data monitor 609 within the central server 621 periodically checks the database 608 against another set of parameters and determines whether any actions are required. There are two main types of actions, one type changes the set points used at the monitoring unit 628 and the other type causes external actions to be initiated by appropriate action apparatus 610. These external actions may consist of sending automatically generated e-mails having pre-determined messages dependent on which parameters cause the actions to human operators. Alternatively these messages may consist of automatic transmissions to pagers and the like to alert human operators. Thus an alarm condition may cause an e-mail to be sent by the central server 621 to a person responsible for maintenance of the plant or equipment. When the system is being used for monitoring stocks of goods or commodities at a remote site the alarm condition which causes an e-mail or other automatic text transmission to be sent to persons responsible for re-ordering the stocks may be the fact that stocks had fallen below a certain level.

While the monitoring unit 628 is connected to the server 621 it may receive new set points from the server 621 and transfer these set points to the read write memory 603. These set points may be changed, for example, to set finer limits on the detection of input signal changes so that future connections between the monitoring unit 628 and the server 621 occur more frequently. Some of the set points may be used to produce output signals at the monitoring unit 628 which may be used to control plant and equipment through an output interface 611. The length of time that an individual monitoring unit 628 is connected to the central server 621 may be controlled by the central server 621 sending a disconnect instruction to the monitoring unit 628. This enables a two way flow of data and ensures that any data which is to be sent from the server 621 to the monitoring unit 628 may be passed to the monitoring unit 628 before the connection is broken. Alternatively, it is possible to cause the monitoring unit 628 to maintain the connection to the server 621 for a set time which is sufficient for the data to be transmitted from the monitoring unit 628 to the server 621 and leaves a period during which data may be sent from the server 621 to the monitoring unit 628. In a further embodiment where no data is to be sent to the monitoring unit 628 the connection may be maintained merely during that time during which data is being sent back to the server 621.

This procedure enables data to be maintained on the database 608 that represents the state of input data at the monitoring unit 628 within the response time of the network. A system user 612 who corresponds to the users 4 and 24 of FIGS. 1 and 2 may use the internet 606 via an internet service provider 613 to access the website 607 on the server 621. In that way the user can access the data from any monitoring unit 628 without needing to be connected to that monitoring unit directly. This information is available at all times and to many users simultaneously, which would not be the case if each user had to connect directly to each monitoring unit. A monitoring unit can normally only be connected to one user at any one time. Of course there may be security procedures involved which limit the number of users who have access to this data.

Assuming that the user has sufficient authorisation it is possible for the user to change the parameters used by the data monitor 609 and the actions 610 which are taken in response to the transmission of those parameters from the monitoring units 628 to the server 621. In this way the user can alter the set points at the monitoring unit and those alterations become effective next time the monitoring unit 618 connects to the server 621. As the is user has access to the website 607 and according to the authorisation held can change data relating to each of a plurality of monitoring unit 628, the user can change the set points in a plurality of monitoring units.

In addition there may be more than one user and they may not necessarily be from the same organisation so that inter business communication can occur. This can arise particularly by using the actions produced by the action apparatus 610 to notify the users of system activity. In this way the user of the plant or equipment, the manufacturer of the plant or equipment and a servicing organisation can all access the data which has been gathered by the website 607 on the central server 621. Where the system is monitoring the state of goods or materials the users having access to the website will include the supplier, the site operator, and possibly a haulage company which is used to deliver the goods or materials. Of course one or more of these users may only be allowed to view a subset of the total data which is relevant to their particular operations. This can be achieved in the normal way of creating and operating web sites where security systems can be put into operation to allow limited access to particular pages on the site using, for example, password control.

1. The provision of a web server and data warehouse to which a plurality of suppliers of goods or services have access using individual web sites hosted by the server, each web site having associated therewith data memory which is arranged to store data received at a supplier's web site over the internet from a plurality of remote terminals arranged at sites owned or operated by a customer of the supplier, access to each web site being restricted to the supplier, to customers of the supplier, or to service or delivery organizations contracted by or belonging to the supplier, wherein: the server is arranged to enter the data received by the web site into the associated memory, to monitor and/or process the stored data to detect a critical state at a remote terminal, and, on detection of a critical state, to notify a person or organization responsible for restoring the site to a non-critical condition of the critical state.

2. The provision of a web server and data warehouse as claimed in claim 1 wherein the server is arranged to notify the person responsible by generating and transmitting an e-mail message.

3. The provision of a web server and data warehouse as claimed in claim 1 in which the server is arranged to generate and transmit a call to a pager.

4. The provision of a web server and data warehouse as claimed in claim 1 in which the server is arranged to generate and transmit a text message to a mobile telephone.

5. The provision of a web server and data warehouse as claimed in claim 1 in which the supplier supplies goods or materials to the customer and the data received by the web site relates to the quantity of goods or materials remaining at the remote site.

6. The provision of a web server and data warehouse as claimed in claim 5 in which the supplier and/or the customer is able to set reorder levels using the web site to enter them into the memory.

7. The provision of a web server and data warehouse as claimed in claim 1 in which the supplier supplies plant or machinery and the data received by the web site relates to operating parameters of the plant or machinery.

8. The provision of a web server and data warehouse as claimed in claim 7 in which the supplier is able to set operating parameters of the plant or machinery using the web site to enter them into the memory.

9. The provision of a web server and data warehouse as claimed in claim 8 in which the web server is enabled to transfer operating parameters to a remote terminal including limit values and the terminal is arranged to transmit an alert signal to the web site immediately a limit value is exceeded.

10. A method of restoring any of a plurality of remote customer sites to a given condition comprising the steps of:
providing a web server hosting one or more web sites, each web site being controlled by a supplier of goods or services to a plurality of customers;
providing respective data store(s) associated with the web site(s)
receiving at a web site data from each a group of remote customer sites, the data representing the current or recent state of the remote site,
storing the received data in the associated data store;
processing the stored data to determine whether a critical condition exists at any of the remote customer sites; and,
if such a critical state is determined notifying a person or organization responsible for restoring the remote site to a given state of the existence of the critical state.

11. A method according to claim 10 comprising the further step of enabling the processed data to be displayed in the web site.

12. A method according to claim 10 comprising the further step of enabling the supplier to enter parameters of critical states or conditions into the server using the web site.

13. A method according to claim 12 comprising the further step of causing the server to transmit the parameters of critical states or conditions to a remote customer site.

14. A method according to claim 10 comprising the further step of causing the remote customer site to transmit data to the server immediately a parameter of the goods reaches a set point value.

15. A method according to claim 10 comprising the further step of enabling the supplier to enter and/or modify details of the person or organization to be notified.
